(19) United States
(12) Patent Application Publication
(10) Pub. No.: US 2023/0184937 A1
(43) Pub. Date: Jun. 15, 2023

(54) Measuring System

(71) Applicant: Nippon Telegraph and Telephone Corporation, Tokyo (JP)

(72) Inventors: Shoji Mochizuki, Musashino-shi, Tokyo (JP); Masayuki Tsuda, Musashino-shi, Tokyo (JP)

(21) Appl. No.: 17/926,076

(22) PCT Filed: May 29, 2020
(86) PCT No.: PCT/JP2020/021360

§ 371 Date: Nov. 17, 2022

(51) Int. Cl. G01S 17/08; G01B 11/02; G01S 17/931

(52) U.S. Cl. CPC G01S 17/08; G01B 11/026; G01S 17/931

(57) ABSTRACT

A measurement system for measuring a movement amount or a position of a mobile body that moves in a measurement area having a rectangular shape includes an omnidirectional movement type mobile body capable of moving in any direction that is mounted with a measuring device for measurement processing for a predetermined purpose, and an orthogonal laser range finder having a gimbal mechanism and individually measures distances to two objects to be measured by using two laser beams orthogonal to each other, a first reflector that is arranged along one side of the measurement area at an outer side and reflects one laser beam of the two laser beams, a second reflector that is arranged orthogonal to the first reflector at an outer side of the measurement area and reflects the other laser beam, and a computer capable of communicating with the measuring device and the orthogonal laser range finder.

### TECHNICAL FIELD

The present invention relates to a measurement system.

### BACKGROUND ART

In a case where work is performed at a disaster site or in an intrusion prohibitive area, a mobile robot is used. A measuring device and a computer are mounted on the mobile robot, and in an unknown measurement area, measurement processing is performed by using the measuring device while moving the mobile robot, and a map is constructed by estimating and calculating a position of itself by using the computer. With this, a state of the measurement area can be recognized in association with a two-dimensional position.

However, there are various road conditions in an outdoor environment in which obstacles or shielding objects are present on a road, so it is necessary to have a control mechanism such as posture control or object recognition in order to achieve a mobile robot suitable for an outdoor environment. Thus, measurement work by using a mobile robot is not yet practical, and a measurement method by remote operation of a mobile robot is not realistic.

On the other hand, even for the measurement work performed in an outdoor environment, when a state of the measurement area is known to a measurer and a position of a measurement point is required to be recognized in the measurement area, a measurement method is commonly used in which a mobile body having a simpler structure than those of mobile robots is used and the measurement is performed by manually moving the mobile body. The mobile body described here is not an apparatus that autonomously performs work, such as a mobile robot, and refers to, for example, a vehicle capable of traveling by a motor drive, a vehicle capable of being moved by human power, or the like.

### CITATION LIST

### Non Patent Literature

NPL 1: Mihai Olimpiu Tatar, et al., “Design and Development of an Autonomous Omni-Directional Mobile Robot with Mecanum Wheels”, 2014 IEEE International Conference on Automation, Quality and Testing, Robotics, Cluj-Napoca, 2014, pp. 1-6.

### SUMMARY OF THE INVENTION

### Technical Problem

Examples of the measuring device described above include an underground surveying device for surveying the underground by using electromagnetic waves. In a case where the ground surface needs to be thoroughly measured at a narrow pitch, such as a case of an underground survey, a movement mechanism in all directions that does not limit the movement direction is preferably provided in the mobile body described above. This is because such a mobile body is convenient in handling and is expected to improve workability. However, it is difficult to two-dimensionally measure a movement amount and a position of a mobile body with high accuracy in the measurement area in the case of using a mobile body capable of moving in any direction.

Examples of a method for measuring the movement amount of a mobile body in all directions include an odometry method (see NPL 1). The odometry method is a method for calculating the movement amount of a mobile body by determining a movement vector based on a wheel rotation amount of each wheel. The method assumes that a plurality of small rollers having a cylindrical shape and being attached at a predetermined angle with respect to the wheel shaft on the circumference of a wheel freely rotate, so that the mobile body slips and moves in any direction in addition to the rotational direction of the wheel. However, the small roller is smaller than the wheel and is slippery with respect to the ground, so that this slippage is integrated as an error of a movement distance and thus, when the movement distance increases, the accuracy of the movement amount and the position cannot be maintained.

Another known method is a self-position estimation method with a laser scanner that is studied in the field of mobile robots. An example of such a method is simultaneous localization and mapping (SLAM) that simultaneously performs estimation calculation of a self-position and creation of a map. A laser detection and ranging (LIDER) sensor is used for a laser scanner. The LIDER sensor performs distance measurement in all the directions in 360 degrees by rotating itself. However, vibration is generated by the rotation, and the accuracy of the measured distance is not high, because the distance measurement is performed while the LIDER sensor is being rotated. In addition, the rotational speed of the sensor is not so high, and thus, sufficient sampling speed cannot be obtained when the mobile body is manually moved.

The present invention has been made in view of the above circumstances, and an object of the present invention is to provide, for a mobile body of an omnidirectional movement type capable of moving in any direction, a technique capable of improving the accuracy of a movement amount and a position of the mobile body.

### Means for Solving the Problem

A measurement system according to an aspect of the present invention is configured to measure a movement amount or a position of a mobile body that moves in a measurement area having a rectangular shape. The measurement system includes: a mobile body mounted with a measuring device configured to perform measurement processing for a predetermined purpose, and an orthogonal laser range finder having a gimbal mechanism and configured to individually measure distances to two objects to be measured by using two laser beams being orthogonal to each other; a first reflector arranged along one side of the measurement area at an outer side of the measurement area and configured to reflect one laser beam of the two laser beams output from the orthogonal laser range finder; a second reflector arranged orthogonal to the first reflector at an outer side of the measurement area and configured to reflect the other laser beam of the two laser beams output from the orthogonal laser range finder; and a computer capable of communicating with the measuring device and the orthogonal laser range finder. The mobile body is of an omnidirectional movement type capable of moving in any direction in the measurement area. The computer includes a first communication unit configured to receive measurement data for the predetermined purpose, the measurement data being measured by the measuring device, a second communication unit configured to receive first distance data between the mobile body and the first reflector and second distance data between the mobile body and the second reflector, the first distance data and the second distance data being measured by the orthogonal laser range finder, and a calculation unit configured to calculate a movement amount and a position of the mobile body in the measurement area based on the first distance data and the second distance data and configured to store the measurement data for the predetermined purpose in association with the measurement amount and the position of the mobile body in a storage unit.

### Effects of the Invention

According to the present invention, it is possible to provide, for the mobile body of the omnidirectional movement type capable of moving in any direction, a technique capable of improving the accuracy of the movement amount and the position of the mobile body.

### BRIEF DESCRIPTION OF DRAWINGS

FIG. 1 is a top view illustrating a configuration of a measurement system.

FIG. 2 is a perspective view illustrating a configuration of an orthogonal laser range finder having a gimbal mechanism.

FIG. 3 is a configuration diagram illustrating a functional block configuration of a computer.

FIG. 4 is a flowchart illustrating an operation of the measurement system.

FIG. 5 is a perspective view illustrating an overall configuration of a belt partition.

FIG. 6 is a diagram illustrating an example of a reflector formed by using the belt partitions.

FIG. 7 is a configuration diagram illustrating a hardware configuration of a computer.

### DESCRIPTION OF EMBODIMENTS

Hereinafter, an embodiment of the present invention will be described with reference to the drawings.

### Outline of the Invention

The present invention discloses a technique by which in order to measure a movement amount and a position in a measurement area with high accuracy in a mobile body of an omnidirectional movement type capable of moving in any direction, the mobile body is mounted with an orthogonal laser range finder having a gimbal mechanism, and orthogonal laser beams output from the orthogonal laser range finder are reflected by two reflectors arranged orthogonal to each other. By using the orthogonal laser range finder with a gimbal function, a posture of the orthogonal laser range finder can be maintained in the original basic posture even when the mobile body performs turning. Furthermore, orthogonal laser beams are reflected by two reflectors arranged orthogonal to each other, so that distances between the mobile body and the reflectors can be accurately measured. As a result, a movement amount and a position of the mobile body can be accurately measured.

The present invention also discloses a technique by which the two reflectors described above are formed by connecting a plurality of belts in series, and the connected belt is hooked to a head portion of a U-shaped arm attached to an upper portion of a reel for housing the belt. Due to this, the adjacent two belts can be brought close to each other, and a gap between the two adjacent belts can be set to zero. Thus, no matter what point in the measurement area the mobile body moves to, the distance to the reflector can be reliably measured, and the movement amount and the position of the mobile body can be reliably measured.

### Measurement System

A configuration of a measurement system according to the present embodiment will be described.

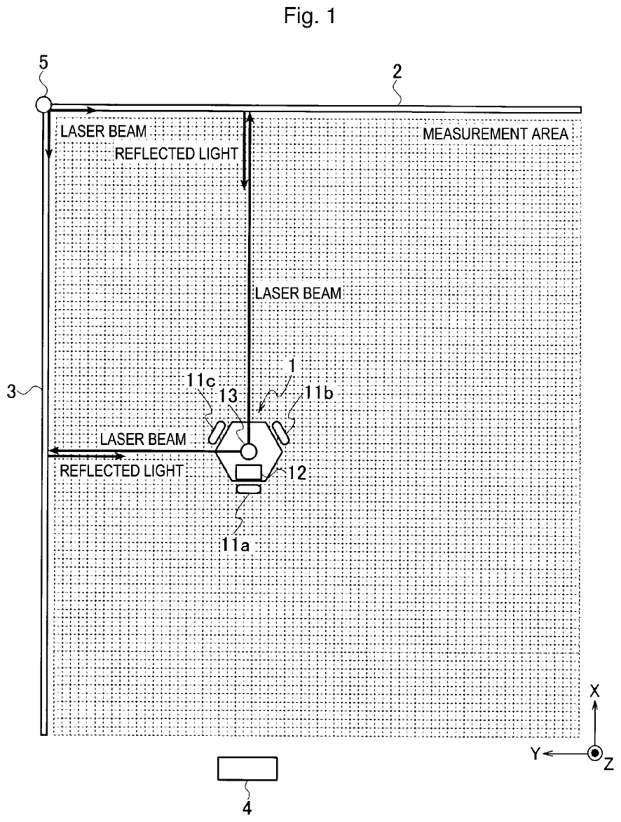

FIG. 1 is a top view illustrating a configuration of a measurement system according to the present embodiment. The measurement system is a measurement system that performs measurement processing for a predetermined purpose in a measurement area having a rectangular shape and at the same time, measures a movement amount and a position of a mobile body 1 in the measurement area with high accuracy. The measurement system includes, for example, the mobile body 1, a first reflector 2, a second reflector 3, and a computer 4.

The mobile body 1 is a mobile body of an omnidirectional movement type capable of moving in any direction. For example, the mobile body 1 includes three wheels 11a to 11c, a measuring device 12, and an orthogonal laser range finder 13.

The three wheels 11a to 11c are rotatably fixed one-to-one to three wheel shafts arranged at intervals of 120 degrees, and are wheels of an omnidirectional movement type that can move the mobile body 1 in any direction by changing a rotational direction and a rotational speed (rotational amount) of each wheel. For example, the wheel 11a includes a wheel having a disc shape and configured to rotate about the wheel shaft, and a plurality of small rollers each of which has a cylindrical shape and is attached at an angle of approximately 45 degrees with respect to the wheel shaft on the circumference of the wheel. The angle of the small roller with respect to the wheel shaft may be 30 degrees, 60 degrees, 90 degrees, or other angles. The wheel 11a may be configured such that a plurality of wheels are overlapped with each other so as to be apart from each other. As described above, the three wheels 11a to 11c include the plurality of small rollers on the circumference of each wheel, so that the mobile body 1 can move in any direction by changing the rotational direction and the rotational speed of each wheel even when the three wheels 11a to 11c are arranged in different orientations by 120 degrees. For example, the three wheels 11a to 11c can be implemented by using omni wheels, Mecanum wheels, or the like.

The measuring device 12 has a function of performing measurement processing for a predetermined purpose. For example, the measuring device 12 is an underground surveying device for surveying underground by using electromagnetic waves, and includes an antenna and a transmitter/receiver that transmit electromagnetic waves into the ground and receive the electromagnetic waves reflected in the ground. The measuring device 12 is not limited to the underground surveying device, and may be another measuring device or a measuring apparatus.

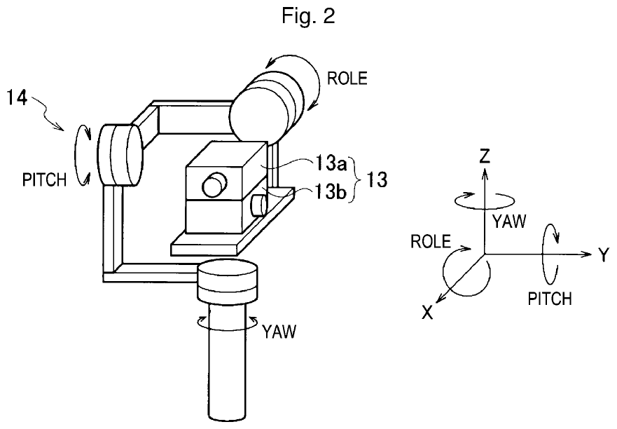

The orthogonal laser range finder 13 has a function of measuring respective distances to two objects by using two laser beams orthogonal to each other. The orthogonal laser range finder 13 may be implemented by using a single laser range finder, or may be implemented by combining a plurality of laser range finders, as long as the respective distances can be measured by using two orthogonal laser beams. For example, the orthogonal laser range finder 13 can be implemented by using two commercially available laser range finders. Specifically, as illustrated in FIG. 2, the orthogonal laser range finder 13 includes a first laser range finder 13a and a second laser range finder 13b that are vertically superimposed. The first laser range finder 13a and the second laser range finder 13b are disposed orthogonal to each other such that orientations of output ends of laser beams are differentiated from each other by 90 degrees so that their optical axes are orthogonal to each other. The first laser range finder 13a outputs a first laser beam to the first reflector 2 and inputs a first reflected light reflected by the first reflector 2 to measure a distance to the first reflector 2 by using the first laser beam and the first reflected light. The second laser range finder 13b outputs a second laser beam to the second reflector 3 and inputs a second reflected light reflected by the second reflector 3 to measure a distance to the second reflector 3 by using the second laser beam and the second reflected light.

The orthogonal laser range finder 13 has a gimbal mechanism 14, as illustrated in FIG. 2. The gimbal mechanism 14 is a mechanism for maintaining and controlling a posture of the orthogonal laser range finder 13 by performing roll rotation, pitch rotation, and yaw rotation about an X axis, a Y axis, and a Z axis, respectively. All the three axes rotate, and thus, even when the mobile body 1 performs turning or the like, the posture of the orthogonal laser range finder 13 is constantly horizontal to the ground surface and can be maintained in a “basic posture” where the outputs of the two laser beams described above are constantly output in the same directions as the original directions. The gimbal mechanism 14 may be configured by combining different parts so as to be capable of rotating about all the three axes, and may be configured by using an integrated member that is rotatable about all the three axes.

Next, the first reflector 2, the second reflector 3, and the computer 4 will be described.

The first reflector 2 is disposed along one side of the measurement area at the outer side of the measurement area and has a function of reflecting one laser beam (the first laser beam described above) of the above-described two laser beams output from the orthogonal laser range finder 13. For example, the first reflector 2 can be implemented by using a tape, a metal rod, a metal pipe, or a reflection wall having glossiness and reflectivity on its surface. The first reflector 2 may be configured by applying fluorescent paint on a surface of plate wood.

The second reflector 3 is disposed orthogonal to the first reflector 2 at the outer side of the measurement area, and has a function of reflecting the other laser beam (the second laser beam) of the two laser beams output from the orthogonal laser range finder 13. For example, the second reflector 3 can also be implemented by using a tape, a metal rod, a metal pipe, or a reflection wall having glossiness and reflectivity on its surface. As in the case of the first reflector 2, the second reflector 3 may be configured by applying fluorescent paint on a surface of plate wood.

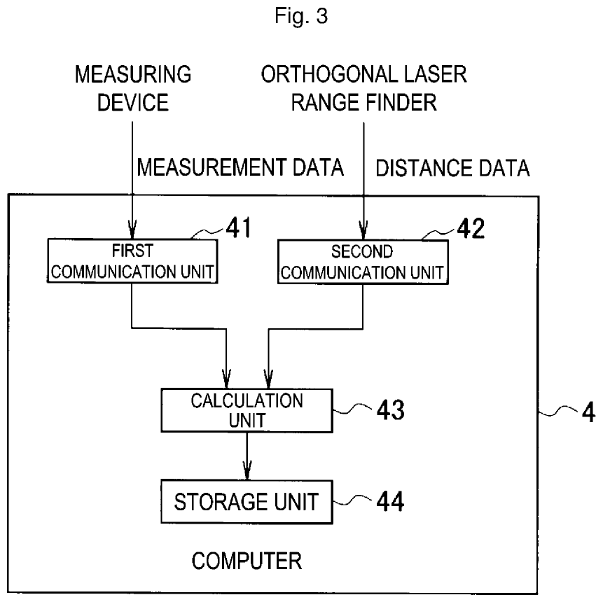

The computer 4 is capable of communicating with the measuring device 12 and the orthogonal laser range finder 13, and includes, as illustrated in FIG. 3, for example, a first communication unit 41, a second communication unit 42, a calculation unit 43, and a storage unit 44.

The first communication unit 41 has a function of receiving measurement data for a predetermined purpose measured by the measuring device 12.

The second communication unit 42 has a function of receiving first distance data between the mobile body 1 and the first reflector 2 and second distance data between the mobile body 1 and the second reflector 3, and first distance data and second distance data are measured by the orthogonal laser range finder 13.

The calculation unit 43 has a function of calculating a movement amount and a two-dimensional position of the mobile body 1 in the measurement area based on the first distance data and the second distance data and storing the above-described measurement data for the predetermined purpose in association with the calculated data of the movement amount and the two-dimensional position of the mobile body 1 in the storage unit 44.

The storage unit 44 has a function of associating the measurement data for the predetermined purpose with the data of the movement amount and the two-dimensional position of the mobile body 1 and storing these pieces of data.

### Measurement Operation

Next, a measurement operation of a movement amount and a position of the mobile body 1 will be described.

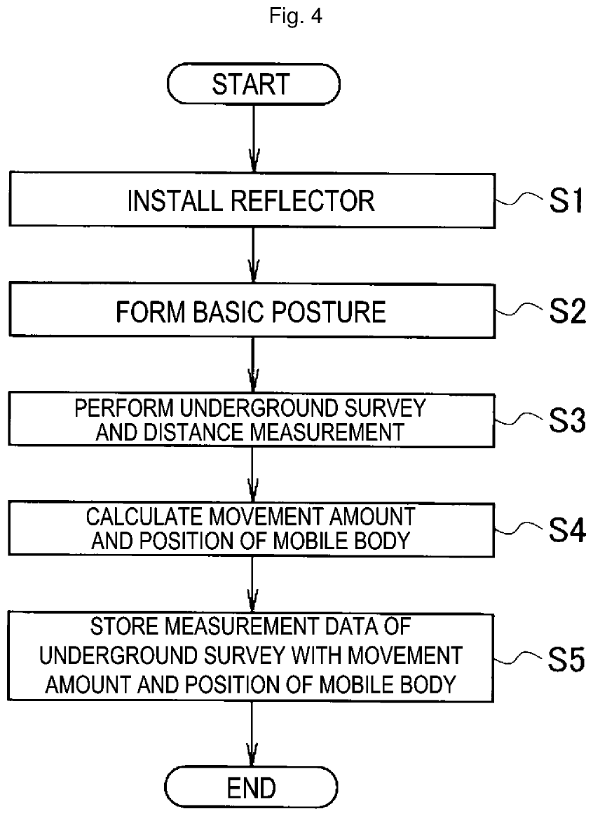

FIG. 4 is a flowchart illustrating an operation of the measurement system. Note that the mobile body 1 is assumed to perform underground survey in a measurement area. The measurement area has a rectangular shape as illustrated in FIG. 1 and its long-side direction is defined as an X-axis direction and its short-side direction is defined as a Y-axis direction.

Step S1:

First, the first reflector 2 is installed at the outer side of the measurement area so as to be parallel to sides in the short-side direction (Y-axis direction) of the measurement area. At the same time as the installation of the first reflector 2, the second reflector 3 is installed at the outer side of the above-described measurement area so as to be parallel to sides in the long-side direction (X-axis direction) of the measurement area. As a result, the first reflector 2 and the second reflector 3 are disposed orthogonal to each other at the outer side of the measurement area.

At this time, in order to enhance the accuracy of orthogonality of the first reflector 2 and the second reflector 3, it is preferable to provide an orthogonal laser marking device 5 (see FIG. 1) at one corner among four corners of the measurement area and to perform positioning along laser beams having high accuracy of orthogonality and output from the orthogonal laser marking device 5. Further, an absolute coordinate position in the measurement area for each position of the first reflector 2 and the second reflector 3 is determined with a position of a landmark or the like near the measurement area used as a reference, or with a latitude/longitude position of satellite positioning information of a global navigation satellite system (GNSS) used as a reference.

A reflector that implements the first reflector 2 and the second reflector 3 is only required to be capable of reflecting a laser beam, like a reflection tape, a metal rod, a reflection wall, or the like, and to have a surface that is planar so that a vertically input laser beam and its reflected light are linear light. In addition, a diameter of a laser beam is very small, and thus, a width of the reflector in the Z-axis direction is widened (thickened) to some extent, and its center position in the Z-axis direction is matched to a height of the laser beam. As a result, even when the mobile body 1 is inclined, the laser beam can be reliably reflected. Consequently, the installation of the reflector is relatively easy.

Step S2:

Next, the mobile body 1 mounted with the measuring device 12 and the orthogonal laser range finder 13 with the gimbal mechanism is placed at a measurement starting position of the above-described measurement area. At this time, X-Y coordinate axes of the orthogonal laser range finder 13 are matched to X-Y coordinate axes of the measurement area. This causes the first laser beam and the second laser beam that are orthogonal to each other of the orthogonal laser range finder 13 to be vertically incident on the first reflector 2 and the second reflector 3, respectively. This state is the basic posture of the mobile body 1. Even in a case where the underground survey is performed by using the measuring device 12 with the mobile body 1 inclined or with the mobile body 1 caused to turn, a state is maintained in which the X-Y coordinate axes of the orthogonal laser range finder 13 are constantly matched to the X-Y coordinate axes of the measurement area, and the first laser beam and the second laser beam can be constantly output in the same directions as the original directions, because the gimbal mechanism 14 enables the orthogonal laser range finder 13 to continue to maintain the basic posture. Thereafter, it is assumed that a user performs the underground survey while manually advancing and turning the mobile body 1.

Step S3:

Next, the measuring device 12 of the mobile body 1 transmits electromagnetic waves into the ground in the measurement area, receives the electromagnetic waves reflected in the ground, and continuously outputs measurement data of the underground survey based on the received electromagnetic waves to the computer 4. In addition, the orthogonal laser range finder 13 of the mobile body 1 measures a distance to the first reflector 2 by using the first laser beam, measures a distance to the second reflector 3 by using the second laser beam, and continuously outputs the two first distance data and second distance data to the computer 4.

Step S4:

Next, the calculation unit 43 of the computer 4 receives the measurement data of the underground survey from the measuring device 12 of the mobile body 1 in conjunction with the manual movement of the mobile body 1 and receives the first distance data and the second distance data from the orthogonal laser range finder 13. Then, the calculation unit 43 calculates a movement amount of the mobile body 1 having moved in the measurement area and a two-dimensional position of the mobile body 1 based on the first distance data and the second distance data. As a simple example, a method in which values of the distance data are used to position coordinates of the mobile body 1 as they are is conceivable. A value of the first distance data measured at time tl is defined as an X1 coordinate and a value of the second distance data measured at time tl is defined as a Y1 coordinate. Thereafter, the mobile body 1 moves and then, a value of the first distance data measured at a subsequent time t2 is defined as an X2 coordinate, and a value of the second distance data measured at the subsequent time t2 is defined as a Y2 coordinate. The movement distance of the mobile body 1 is calculated by using a calculation expression of “|(X2, Y2)−(X1, Y1)|”. At this time, this relative coordinate position may be converted to absolute position coordinates based on an absolute coordinate system of the measurement area with a latitude/longitude position or the like being as a reference.

Step S5:

Finally, the calculation unit 43 stores the measurement data of the underground survey received from the measuring device 12 in the storage unit 44 in association with the calculated data described above of the movement amount and the two-dimensional position of the mobile body 1.

In this way, the orthogonal laser range finder 13 with the gimbal mechanism is mounted on the mobile body 1, so the posture of the orthogonal laser range finder 13 can be maintained in the original basic posture even when the mobile body 1 performs turning. In addition, the orthogonal laser beams are reflected by the first reflector 2 and the second reflector 3 orthogonally arranged, and thus, the distance between the mobile body 1 and each of the reflectors can be accurately measured. As a result, the movement amount and the position of the mobile body 1 can be accurately measured. Furthermore, even when the mobile body 1 two-dimensionally and freely moves in the measurement area, the orthogonal laser range finder 13 continues to constantly measure distances from the two reflectors, and thus, the mobile body 1 can identify a self-position with high accuracy without losing the self-position. The laser range finder can measure a distance with very high accuracy in only one direction and is applicable to a far distance. Also, a sampling speed for acquiring a distance can be set relatively quickly and can also follow a speed of the manual movement.

### Specific Example and Forming Example of Reflector

Next, a specific example of the first reflector 2 and the second reflector 3 will be described.

For example, a steel plate fence having a flat plate shape can be used as the reflector. However, in a case of the steel plate fence, a plurality of steel plate fences need to be installed, and a weight thereof is heavy, which leads to a lack of compactness and portability. Thus, for example, a belt such as a belt partition or a barrier reel is preferably used as the reflector.

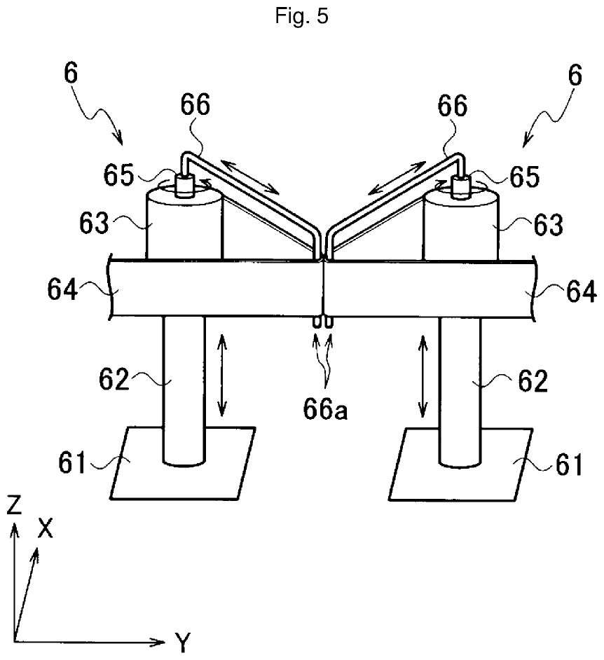

FIG. 5 is a perspective view illustrating an overall configuration of a belt partition 6. The belt partition 6 includes a pole 62 being extendable in the Z-axis direction and attached on a base 61 and a reel 63 having a cylindrical shape at an upper end of the pole 62. The reel 63 is a main body of the belt partition 6, a winding shaft member inside the reel 63 rotates to wind the belt 64, and the belt 64 is housed inside the reel 63. Such a belt partition 6 is small and lightweight, can house the belt in a compact manner, can be installed at any place, and thus, can be used regardless of the place of a measurement area.

However, a belt length of the belt 64 has an upper limit, so that it is necessary to have a joint when the belt partition 6 is installed in a measurement area having a large longitudinal width and a large lateral width. A method in which the belt partition having a long belt length is used is also conceivable, but the belt may be loosened by its own weight and may not reliably reflect a laser beam.

Thus, in the present embodiment, a plurality of belt partitions is used in such a manner that the plurality of belt partitions are connected in series. At this time, a lateral width of the base 61 in the Y-axis direction is typically larger than a lateral width of the reel 63 in order to maintain a standing state of the belt partition 6. Thus, even when the two belt partitions are simply made adjacent to each other, a gap is generated between the two belts, so that the two belts become discontinuous.

Thus, in the present embodiment, as illustrated in FIG. 5, a support shaft 65 that rotates about the Z axis and whose rotational position can be fixed (locked) is provided on the reel 63, and a U-shaped arm 66 being extendable in a two-dimensional direction of X-Y coordinates is attached to the support shaft 65. Then, the belt 64 is hooked to a head portion 66a of the U-shaped arm 66 and two U-shaped arms 66 are rotated and extended/contracted so that a gap (separation distance) between the adjacent two belts 64 becomes zero. This can form one long reflector having continuity of the surface. Thus, no matter what point in a measurement area the mobile body 1 moves to, a distance to the reflector can be reliably measured, and a movement amount and a position of the mobile body 1 can be reliably measured.

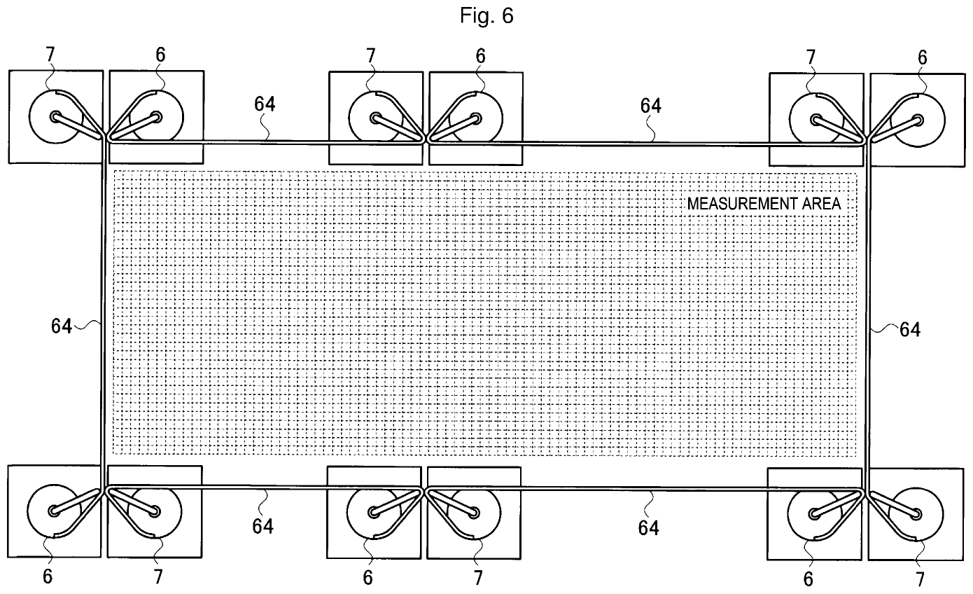

FIG. 6 is a diagram illustrating an example of a reflector formed by using a plurality of belt partitions 6. In the figure, a reference sign 7 denotes a belt partition on a receiving side to which a tip portion of the belt 64 of the belt partition 6 is attached.

Only two sides orthogonal to each other are sufficient for the reflector, but some states of the measurement area require four sides of the measurement area to be surrounded, and thus, the case where the four sides are surrounded is exemplified. As illustrated in FIG. 6, even in a case where the belts 64 of the plurality of belt partitions 6 are used, a reflector that does not have a gap and that surrounds all four sides can be formed. Further, surrounding the work area has an effect of preventing a third party from entering the work area.

The surface of the belt 64 on the measurement area side may be colored in white, and a tiger-striped pattern or a pattern for attracting attention such as an off-limits area may be drawn on the outer surface. When the inner surface of the belt 64 is colored in white, the reflection intensity of a laser beam can be increased and the accuracy of distance measurement can be improved. Drawing the pattern for attracting attention on the outer surface of the belt 56 enables the effect of preventing entry to the measurement area to be further enhanced. In addition, typically, in order to ensure safety, the work area needs to be surrounded by using color cones and cone bars, but the belts 64 themselves can play such a role.

### Other Configurations

The mobile body 1 may include a gyro sensor. With the gyro sensor, an orientation of the mobile body 1 can be constantly recognized.

### Effects

According to the present embodiment, the mobile body 1 is mounted with the orthogonal laser range finder 13 having a gimbal mechanism and configured to individually measure distances to two objects to be measured by using two laser beams being orthogonal to each other, the first reflector 2 configured to reflect one laser beam of the two laser beams is disposed along one side of a measurement area having a rectangular shape, and the second reflector 3 configured to reflect the other laser beam is disposed orthogonal to the first reflector 2, thereby maintaining a posture of the orthogonal laser range finder 13 in the original basic posture and allowing a distance between the mobile body 1 and each of the first reflector 2 and the second reflector 3 to be accurately measured. As a result, a movement amount and a position of the mobile body 1 can be accurately measured.

Further, according to the present embodiment, the first reflector 2 and the second reflector 3 are formed by connecting a plurality of belts in series, and each belt is hooked to the head portion 66a of the U-shaped arm 66 attached to the upper portion of the reel 63 for housing the belt, thereby allowing two adjacent belts to be brought close to each other and making a gap between the two adjacent belts be zero. As a result, no matter what point in the measurement area the mobile body 1 moves to, the distance to each reflector can be reliably measured and a movement amount and a position of the mobile body 1 can be reliably measured.

In other words, as the orthogonal laser range finder 13 having a gimbal function is used, the basic posture of the orthogonal laser range finder 13 can be maintained by following turning of the mobile body 1, and a distance to each of the reflectors disposed orthogonal to each other can be accurately measured and a self-position can be accurately acquired even in a case where two-dimensional scanning is performed in the measurement area. Also, there is no accumulation of errors based on a cruising distance, and thus, it is also possible to adapt to a long cruising distance while maintaining high accuracy. The reflector can also provide effects as intrusion prevention and a safety measure, which leads to reduction of materials necessary for measurement. Furthermore, in combination with satellite positioning that can obtain absolute coordinates, an effect that can be expanded to acquisition of absolute coordinates with high accuracy is also exhibited.

### Hardware Configuration of Terminal

The present invention is not limited to the embodiment described above. The present invention can be variously modified within the scope of the gist of the present invention.

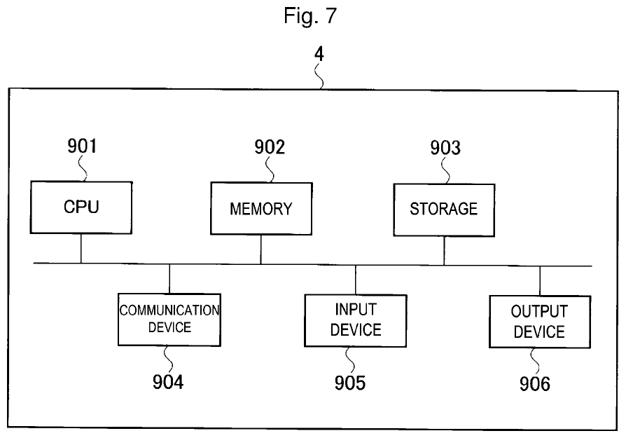

The aforementioned computer 4 according to the present embodiment, for example, as illustrated in FIG. 7, can be implemented by using a general-purpose computer system including a central processing unit (CPU, a processor) 901, a memory 902, a storage (a hard disk drive (HDD), a solid state drive (SSD)) 903, a communication device 904, an input device 905, and an output device 906. The memory 902 and the storage 903 are storage devices. In the computer system, the CPU 901 executes a predetermined program loaded in the memory 902 to achieve each function of the computer 4.

The computer 4 may be implemented with one computer. The computer 4 may be implemented with a plurality of computers. Also, the computer 4 may be a virtual machine implemented in a computer. A program for the computer 4 may be stored in a computer-readable recording medium such as an HDD, an SSD, a universal serial bus (USB) memory, a compact disc (CD), and a digital versatile disc (DVD). The program for the computer 4 may also be distributed via a communication network.

### REFERENCE SIGNS LIST

1 Mobile body
2 First reflector
3 Second reflector
4 Computer
5 Orthogonal laser marking device
6 Belt partition
7 Belt partition on receiving side
11a to 11c Wheel
12 Measuring device
13 Orthogonal laser range finder
13a First laser range finder
13b Second laser range finder
14 Gimbal mechanism
41 First communication unit
42 Second communication unit
43 Calculation unit
44 Storage unit
61 Base
62 Pole
63 Reel
64 Belt
65 Support shaft
66 U-shaped arm
66a Head portion

1. A measurement system configured to measure a movement amount or a position of a mobile body that moves in a measurement area having a rectangular shape, the measurement system comprising:
a mobile body mounted with
a measuring device configured to perform measurement processing for a predetermined purpose, and
an orthogonal laser range finder having a gimbal mechanism and configured to individually measure distances to two objects to be measured by using two laser beams being orthogonal to each other,
the mobile body being of an omnidirectional movement type capable of moving in any direction in the measurement area;
a first reflector arranged along one side of the measurement area at an outer side of the measurement area and configured to reflect one laser beam of the two laser beams output from the orthogonal laser range finder;
a second reflector arranged orthogonal to the first reflector at an outer side of the measurement area and configured to reflect the other laser beam of the two laser beams output from the orthogonal laser range finder; and
a computer capable of communicating with the measuring device and the orthogonal laser range finder,
wherein
the computer includes
a first communication unit configured to receive measurement data for the predetermined purpose, the measurement data being measured by the measuring device,
a second communication unit configured to receive first distance data between the mobile body and the first reflector and second distance data between the mobile body and the second reflector, the first distance data and the second distance data being measured by the orthogonal laser range finder, and
a calculation unit configured to calculate a movement amount and a position of the mobile body in the measurement area based on the first distance data and the second distance data and configured to store the measurement data for the predetermined purpose in association with the measurement amount and the position of the mobile body in a storage unit.

2. The measurement system according to claim 1, wherein the first reflector and the second reflector are formed of a belt.

3. The measurement system according to claim 2, wherein the belt is a belt hooked to a head portion of a U-shaped arm attached to an upper portion of a reel configured to house the belt.
